(19) United States
(12) Patent Application Publication
(10) Pub. No.: US 2026/0078221 A1
(43) Pub. Date: Mar. 19, 2026

(54) ELECTRICALLY CONDUCTIVE MOISTURE-CURABLE COMPOSITION

(71) Applicant: Henkel AG & Co. KGaA, Duesseldorf (DE)

(72) Inventors: Cuirui Luo, Shanghai (CN); Lili Yan, Shanghai (CN); Bin Zhao, Shanghai (CN); Chenyu Huang, Shanghai (CN); Zheng Shi, Shanghai (CN); Mingxin Li, Nanjing (CN); Weihao Zhang, Shanghai (CN); Xiaolong Hu, Shanghai (CN)

(21) Appl. No.: 19/401,662

(22) Filed: Nov. 26, 2025

Related U.S. Application Data
(63) Continuation-in-part of application No. PCT/CN2023/097758, filed on Jun. 1, 2023.

(30) Foreign Application Priority Data
May 30, 2024 (TW) 113119930

(51) Int. Cl. C08G 77/04; B05D 3/06; C08G 77/08; C08K 3/08; C08K 5/103; C08K 5/49; C08K 5/5425; C08K 5/5435; C08K 5/544

(52) U.S. Cl. CPC C08G 77/045; B05D 3/067; C08G 77/08; C08K 3/08; C08K 5/103; C08K 5/49; C08K 5/5425; C08K 5/5435; C08K 5/5477; B05D 2518/12; B05D 2601/28; C08K 2003/0806; C08K 2201/001

(57) ABSTRACT

The present invention provides an electrically conductive moisture-curable composition, a method of applying the composition, a cured product of the composition, an article comprising the cured product, and a use of the composition or the cured product wherein the composition comprises: (A) a polyfunctional silane compound having at least two alkoxysilane groups, (B) a moisture scavenger, (C) an alkoxysilane isocyanurate compound and optionally an epoxy functional silane coupling agent, (D) a photo-acid generator, which is a sulfonium salt, (E) a moisture-curing catalyst, and (F) an electrically conductive filler.

### TECHNICAL FIELD

The present invention relates to an electrically conductive moisture-curable composition, and particularly relates to an electrically conductive moisture-curable composition which can be cured at room temperature with a fast surface drying and a good stability, and has a low resistivity; a method of applying the composition, a cured product of the composition, an article comprising the cured product, and a use of the composition or the cured product.

### BACKGROUND OF THE INVENTION

Currently, electronic products mostly use plastic as frame, which is heat-sensitive; and thus, a low temperature curable composition, especially a room temperature curable composition, is needed. Existing electrically conductive room-temperature curable compositions normally comprise: a modified silane polymer, an electrically conductive filler, and a base (such as, 3-aminopropyltrimethoxysilane). However, it is difficult to balance the tack free time and stability of these compositions; that is to say, these compositions cannot have both a fast surface drying and a good stability.

Moreover, for rapid production, light cured or moisture cured adhesives are first choice. However, light cured electrically conductive adhesive has a curing depth limitation because of a low transmittance; and acrylate and NCO hybrid chemistry can exhibit a fast surface drying performance, but a bad stability when being mixed with an electrically conductive filler.

In view of the above, it would be desirable to provide an electrically conductive moisture-curable composition which can be cured at room temperature with a fast surface drying and a good stability, and has a low resistivity.

### SUMMARY OF THE INVENTION

The present invention provides an electrically conductive moisture-curable composition comprising:
(A) a polyfunctional silane compound having at least two alkoxysilane groups,
(B) a moisture scavenger,
(C) an alkoxysilane isocyanurate compound and optionally an epoxy functional silane coupling agent,
(D) a photo-acid generator, which is a sulfonium salt,
(E) a moisture-curing catalyst, and
(F) an electrically conductive filler.

The present invention also provides a method of applying the electrically conductive moisture-curable composition according to the present invention comprising: applying the composition on a substrate, UV curing the composition to obtain a cured product, and then moisture curing the cured product.

The present invention further provides a cured product of the electrically conductive moisture-curable composition according to the present invention.

In addition, the present invention provides an article comprising the cured product according to the present invention.

Moreover, the present invention provides a use of the electrically conductive moisture-curable composition according to the present invention or the cured product according to the present invention in electronic products.

All of the electrically conductive moisture-curable composition, the method of applying such a composition, the cured product, the article and the use according to the present invention are based on the following surprising discoveries of the inventors: the electrically conductive moisture-curable composition according to the present invention comprising a combination of components (A) to (F) can be cured at room temperature with a fast surface drying and a good stability, and has a low resistivity; and in particular, it exhibits a combination of a tack free time (No UV)>4 hours, a tack free time (LED 365 nm, 3 w/cm²*2 s)≤2 minutes, a liquid state at room temperature (RT) after 4 hours (No UV), a conductivity after 7 days≤0.05 ohm*cm, and a curing depth after 24 hours≥0.5 mm.

### DETAILED DESCRIPTION OF THE INVENTION

It is to be understood by one of ordinary skill in the art that the present discussion is a description of exemplary embodiments only and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, as used herein, the terms “a”, “an” and “the” include both singular and plural referents. That is to say, the terms “a”, “an” and “the” are used interchangeably with “at least one” to mean one or more of the elements being described.

The terms “comprising” and “comprises” as used herein are synonymous with “including”, “includes”, “containing” or “contains”, and are inclusive or open-ended and do not exclude additional, non-recited members, elements or process steps.

Unless specified otherwise, the recitation of numerical end points includes all numbers and fractions subsumed within the respective ranges, as well as the recited end points.

Unless specified otherwise, all the term “room temperature” used herein refers to 23±2° C.

Unless otherwise defined, all terms used in the disclosing the invention, including technical and scientific terms, have the meaning as commonly understood by one of the ordinary skill in the art to which this invention belongs.

According to the present invention, surprisingly, the inventors of the present invention found that an electrically conductive moisture-curable composition comprising:
(A) a polyfunctional silane compound having at least two alkoxysilane groups,
(B) a moisture scavenger,
(C) an alkoxysilane isocyanurate compound and optionally an epoxy functional silane coupling agent,
(D) a photo-acid generator, which is a sulfonium salt,
(E) a moisture-curing catalyst, and
(F) an electrically conductive filler,
   can be cured at room temperature with a fast surface drying and a good stability, and has a low resistivity.

In a first aspect, the present disclosure is generally directed to an electrically conductive moisture-curable composition comprising:
(A) a polyfunctional silane compound having at least two alkoxysilane groups,
(B) a moisture scavenger,
(C) an alkoxysilane isocyanurate compound and optionally an epoxy functional silane coupling agent,
(D) a photo-acid generator, which is a sulfonium salt,
(E) a moisture-curing catalyst, and
(F) an electrically conductive filler.

### (A) Polyfunctional Silane Compound Having at Least Two Alkoxysilane Groups

According to the present invention, the electrically conductive moisture-curable composition comprises (A) a polyfunctional silane compound having at least two alkoxysilane groups.

Preferably, the polyfunctional silane compound having at least two alkoxysilane groups (A) comprises one or more at least bifunctional α-alkoxysilane compounds, which preferably corresponds to the following formula (III):

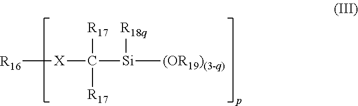

wherein
R₁₆ is an at least divalent organic residue,
each R₁₇, independently, is a monovalent residue that is selected from the group consisting of hydrogen, linear, branched, cyclic, saturated, unsaturated and aromatic hydrocarbons and, optionally, may be halogen-substituted and/or interrupted by 1 to 3 heteroatoms,
each R₁₈, independently, is a monovalent residue that is selected from the group consisting of linear, branched, cyclic, saturated, unsaturated and aromatic hydrocarbons and, optionally, may be halogen-substituted and/or interrupted by 1 to 3 heteroatoms,
each R₁₉, independently, is a monovalent residue that is selected from the group consisting of hydrogen, linear, branched, cyclic, saturated, unsaturated and aromatic hydrocarbons and, optionally, may be halogen-substituted and/or interrupted by 1 to 3 heteroatoms,
X is a heteroatom-containing di- or trivalent residue that is linked, via a heteroatom, in particular oxygen, nitrogen or sulfur, to the —CR₁₇₂—SiR_{18q}(OR₁₉)_{(3-q)} group,
p is at least 2, and
q=0 to 2.

More preferably, in the formula (III), R₁₆ is a residue selected from the groups consisting of (i) linear or branched, saturated or unsaturated alkyl residues having 1 to 8 C atoms, optionally interrupted by 1 to 3 heteroatoms, (ii) saturated or unsaturated cycloalkyl residues having 3 to 9 C atoms, optionally interrupted by 1 to 3 heteroatoms, (iii) aromatic residues having 5 to 10 C atoms, (iv) polyolefin, polyether, polyamide, polyester, polycarbonate, polyurethane, polyurea, siloxanes, polybutadienes, hydrogenated polybutadienes or polyacrylate, wherein each R₁₆ can be unsubstituted or bear further substituents.

Particularly preferably, R₁₆ is a polymeric residue of the above-mentioned group (iv), preferably with terminal alkoxysilane groups according to formula (III).

The compounds of general formula (III) are so-called α-alkoxysilane compounds which are characterized in that the (alkoxy)silane groups are in an α-position relative to a heteroatom such as oxygen, sulfur or nitrogen. The alkoxysilane group is separated from the heteroatom by a substituted or unsubstituted methylene group.

Preferably, the residue R₁₆ is a polymer backbone or copolymer backbone based on a polyether, polyester, polycarbonate, polyurethane, polyamide and polyuria.

Particularly preferably, the residue R₁₆ is a polyurethane or polyether residue.

The heteroatom-containing residue X preferably means a heteroatom-containing divalent residue such as —O—, —S—, —N(R)—, —C(O)—O—, —O—C(O)—O—, —O—C(O)—O—N(R)—, —N(R)—C(O)—O—, —S(O)—, —S(O)₂—, —S(O)—O—, —S(O)₂—O—, —O—S(O)₂—O—, —C(O)—N(R)—, —S(O)₂—N(R)—, —S(O)₂—N[C(O)R]—, —O—S(O)₂—N(R)—, —N(R)—S(O)₂—O—, —P(O)(OR)—O—, —O—P(O)(OR)—, —O—P(O)(OR)—O—, —P(O)(OR)—N(R)—, —N(R)—P(O)(OR)—, —O—P(O)(OR)—N(R)—, —N(R)—P(O)(OR)—O—, —N[C(O)R]—, —N═C(R)—O—, —(R)═N—O—, —C(O)—N[C(O)R]—, —N[S(O)₂R′]—, —C(O)—N[S(O)₂R′]— or —N[P(O)R″₂]—, with R representing hydrogen or optionally substituted C₁-C₂₀ alkyl or C₆-C₂₀ aryl residues, and R″ representing an optionally substituted C₁-C₂₀ alkyl, C₆-C₂₀ aryl, C₁-C₂₀ alkoxy or C₆-C₂₀ aryloxy residue.

Particularly preferably, X in the general formula (III) represents an oxygen or nitrogen atom or a carboxy, carbamate, ureido, urethane or sulfonate bond.

R₁₇ is preferably hydrogen. R₁₈ is preferably C₁-C₆ alkyl, in particular methyl or ethyl, or phenyl.

The residue R₁₉ in general formula (III) preferably means a methyl or ethyl group. Preferably, q=0 or 1. Furthermore, two R₁₉ residues can be bridged to form a cycle.

According to another preferred embodiment, the residue R₁₇ is hydrogen, R₁₈ and R₁₉ mean methyl groups and q=1.

Many of the preferred α-silanes based on polyethers or polyurethanes are commercially available from Wacker Chemie AG. They are commercially sold under the trade name Geniosil STPE. Examples are the STPE-10, STPE-30 types.

Example of commercially available component (A) may also include Geniosil XB502, Geniosil XT50, and Geniosil XT55 available from Wacker.

In a preferred embodiment of the present invention, component (A) comprises a mixture of Geniosil STPE-10 and Geniosil XB502.

Preferably, the amount of component (A) is from 3 to 50 wt. %, preferably from 5 to 35 wt. %, and more preferably from 5 to 25 wt. %, each based on the total weight of the composition. If the amount of component (A) is higher than 50 wt. %, the electrical conductivity of the product obtained from the composition becomes worse. If the amount of component (A) is lower than 3 wt. %, the composition cannot be cured into a film, and the final product of the composition does not have an electrical conductivity.

The component (A) in the present invention does not cover an epoxy functional silane coupling agent, which will be discussed hereinbelow.

### (B) Moisture Scavenger

According to the present invention, the electrically conductive moisture-curable composition comprises (B) a moisture scavenger, which is added to remove any moisture from the ambient or raw materials, so as to increase the shelf life stability of the composition.

Examples of the moisture scavenger (B) include, but are not limited to: vinylsilanes, such as vinyltrimethoxysilane, vinyltriethoxysilane, vinylmethyldimethoxysilane, and 3-vinylpropyltriethoxysilane. Preferably, the moisture scavenger (B) used in the present invention is a vinylsilane. More preferably, the moisture scavenger (B) is selected from the group consisting of vinyltrimethoxysilane, vinyltriethoxysilane, vinylmethyldimethoxysilane, and combinations thereof. Most preferably, the moisture scavenger (B) is vinyltrimethoxysilane.

Examples of commercially available component (B) include, but are not limited to, Dynasylan VTMO, available from Evonik; and Geniosil XL (VTMO), available from Wacker.

Preferably, the amount of component (B) is from 0.3 to 2 wt. %, preferably from 0.4 to 1.0 wt. %, each based on the total weight of the composition. If the amount of component (B) is higher than 2 wt. %, the moisture-cure speed of the composition will be negatively affected. If the amount of component (B) is lower than 0.3 wt. %, the stability of the product will be negatively affected.

### (C) Alkoxysilane Isocyanurate Compound and Optionally Epoxy Functional Silane Coupling Agent

According to the present invention, the electrically conductive moisture-curable composition comprises (C) an alkoxysilane isocyanurate compound and optionally an epoxy functional silane coupling agent.

Preferably, the alkoxysilane isocyanurate compound used in the present invention is represented by the following general formula (I):

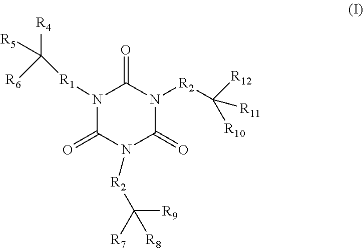

wherein R₁, R₂ and R₃ are each independently of the other C₁-C₈ alkyl, preferably C₂-C₆ alkyl, more preferably C₃-C₄ alkyl; and each of R₄ to R₁₂ is independently of the other C₁-C₄ alkyl or C₁-C₄ alkoxy, preferably C₁-C₂ alkyl or C₁-C₂ alkoxy, and more preferably C₁-C₂ alkoxy; with the proviso that at least one of R₄ to R₁₂ is C₁-C₄ alkoxy.

In a preferred embodiment of the present invention, the alkoxysilane isocyanurate compound is selected from the group consisting of 1,3,5-tris(trimethoxysilylpropyl)isocyanurate, 1,3,5-tris(methyldimethoxysilylpropyl)isocyanurate, 1,3,5-tris(methyldiethoxysilylpropyl)isocyanurate, 1,3,5-tris(trimethoxysilylbutyl)isocyanurate, 1,3,5-tris(methyldimethoxysilylbutyl)isocyanurate, 1,3,5-tris(triethoxysilylpropyl)isocyanurate, and combinations thereof. Preferably, the alkoxysilane isocyanurate compound is selected from the group consisting of 1,3,5-tris(trimethoxysilylpropyl)isocyanurate, 1,3,5-tris(trimethoxysilylbutyl)isocyanurate, and combinations thereof, More preferably, the alkoxysilane isocyanurate compound is 1,3,5-tris(trimethoxysilylpropyl)isocyanurate.

Examples of commercially available alkoxysilane isocyanurate compound include, but are not limited to, Dynasylan 7163 (1,3,5-tris(trimethoxysilylpropyl)isocyanurate) and Dynasylan 7161 (1,3,5-tris(trimethoxysilylpropyl)isocyanurate), both available from Evonik; T-33 (1,3,5-tri(trimethoxysilylpropyl))cyanaurate, available from Huaian Hongtu New Material Co., Ltd.; and KBM-9658 (1,3,5-tri(trimethoxysilylpropyl))cyanaurate), available from ShinEtsu. Preferably, the alkoxysilane isocyanurate compound is the one under the trade name of Dynasylan 7163 available from Evonik.

If present, the epoxy functional silane coupling agent used in the present invention is preferably selected from the group consisting of 3-glycidyloxypropyltrimethoxysilane, 3-glycidyloxypropylmethyldiethoxysilane, 3-glycidyloxypropyltriethoxysilane, 2-(3,4-epoxycyclohexyl)-ethyltrimethoxysilane, and combinations thereof. More preferably, the epoxy functional silane coupling agent is 3-glycidyloxypropyltrimethoxysilane.

Examples of commercially available epoxy functional silane coupling agent used in the present invention include, but are not limited to, Silquest A-187, Silquest Wetlink 78, Silquest A-1871, and Silquest A-186, all of which are available from Momentive; Dynasylan 4721, Dynasylan GLYMO and Dynasylan GLYEO, available from Evonik; SCA-403, SCA-412, SCA-413 and SCA-4603, all of which are available from Itochu Corporation; Dow Corning Z-6040, Dow Corning Z-6042, Dow Corning Z-6041, and Dow Corning Z-6043, all of which are available from Dow Corning; KBM-403, KBM-303, KBE-402 and KBE-403, all of which are available from Shin-Etsu Chemical Co., Ltd.; GF80, GF84 and GF82, all of which are available from Wacker Chemie AG. Preferably, the epoxy functional silane coupling agent used in the present invention is the one under the trade name of Silquest A-187, available from Momentive.

In a preferred embodiment of the present invention, the amount of component (C) is from 0.5 to 20 wt. %, preferably from 1 to 8 wt. %, each based on the total weight of the composition. If the amount of component (C) is higher than 20 wt. %, the crosslinking density of the product will be too large, and the film obtained from the composition will be brittle. If the amount of component (C) is lower than 0.5 wt. %, the tack free time of the composition will be too long and the time for obtaining the electrical conductivity of the composition will be too long.

(D) Photo-Acid Generator, which is a Sulfonium Salt

According to the present invention, the electrically conductive moisture-curable composition comprises (D) a photo-acid generator, which is a sulfonium salt.

Preferably, the photo-acid generator (D) is an aromatic sulfonium compound. More preferably, the aromatic sulfonium compound is represented by the following general formula (II):

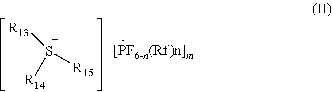

wherein R₃, R₁₄ and R₁₅ each independently represent a monovalent aromatic group which may have a substituent on an aromatic ring, the monovalent aromatic group may optionally have one or two or more of a bond selected from —S— (thioether bond), —SO— (sulfoxide bond), —O— (ether bond) and —O— (carbonyl bond); Rf represents a fluoroalkyl group, preferably a C₁-C₁₀ fluoroalkyl group, more preferably a C₁-C₈ fluoroalkyl group, most preferably a C₁-C₄ fluoroalkyl group; m is the same number as the cationic charge of the “cation [S⁺(R₁₃)(R₁₄)(R₁₅)]”, and n is an integer in a range of 0 to 6.

In a preferred embodiment of the present invention, the cation [S⁺(R₁₃)(R₁₄)(R₁₅)] in the aromatic sulfonium compound is selected from the group consisting of the following cations (a-1) to (a-20):

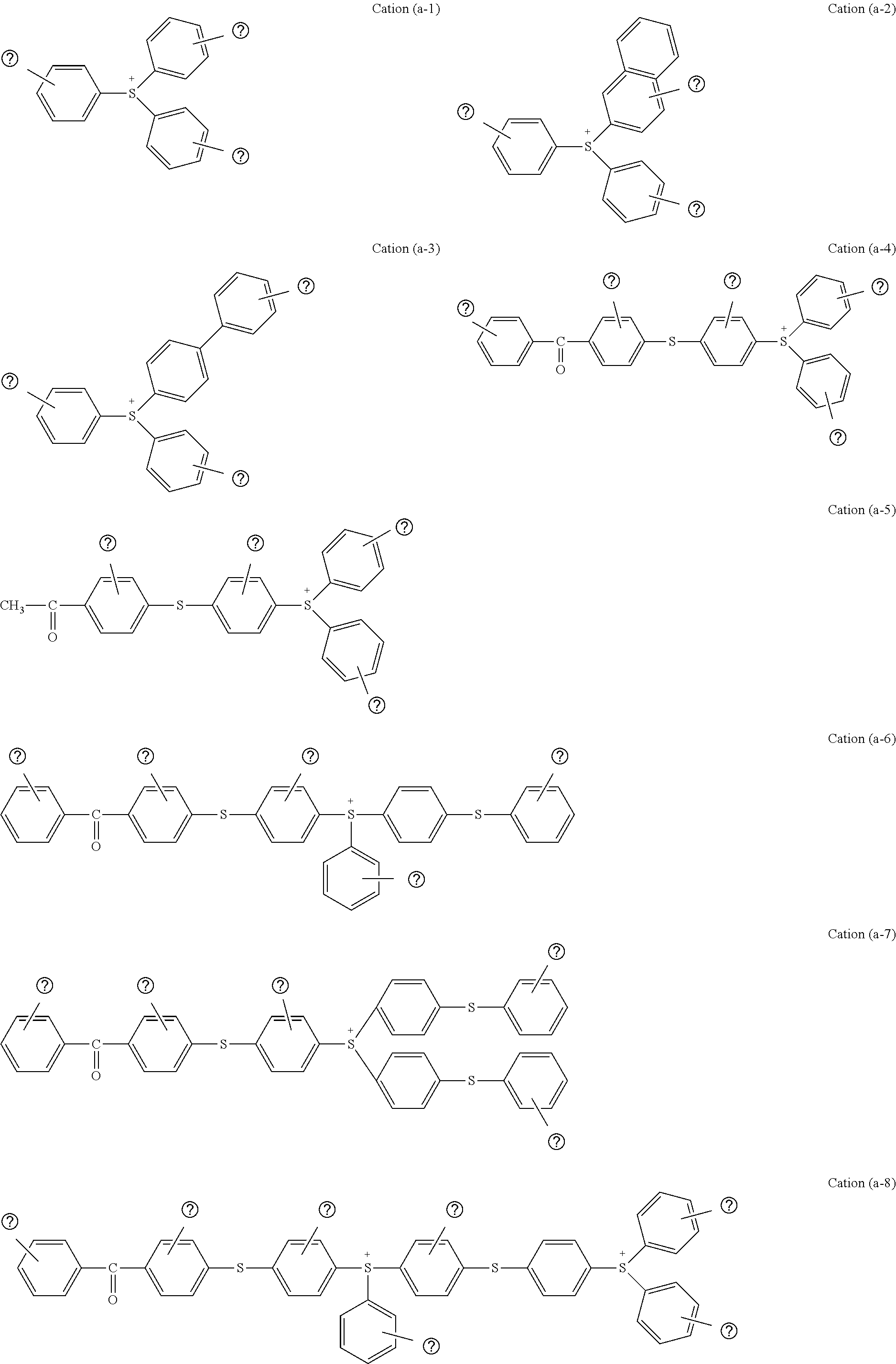

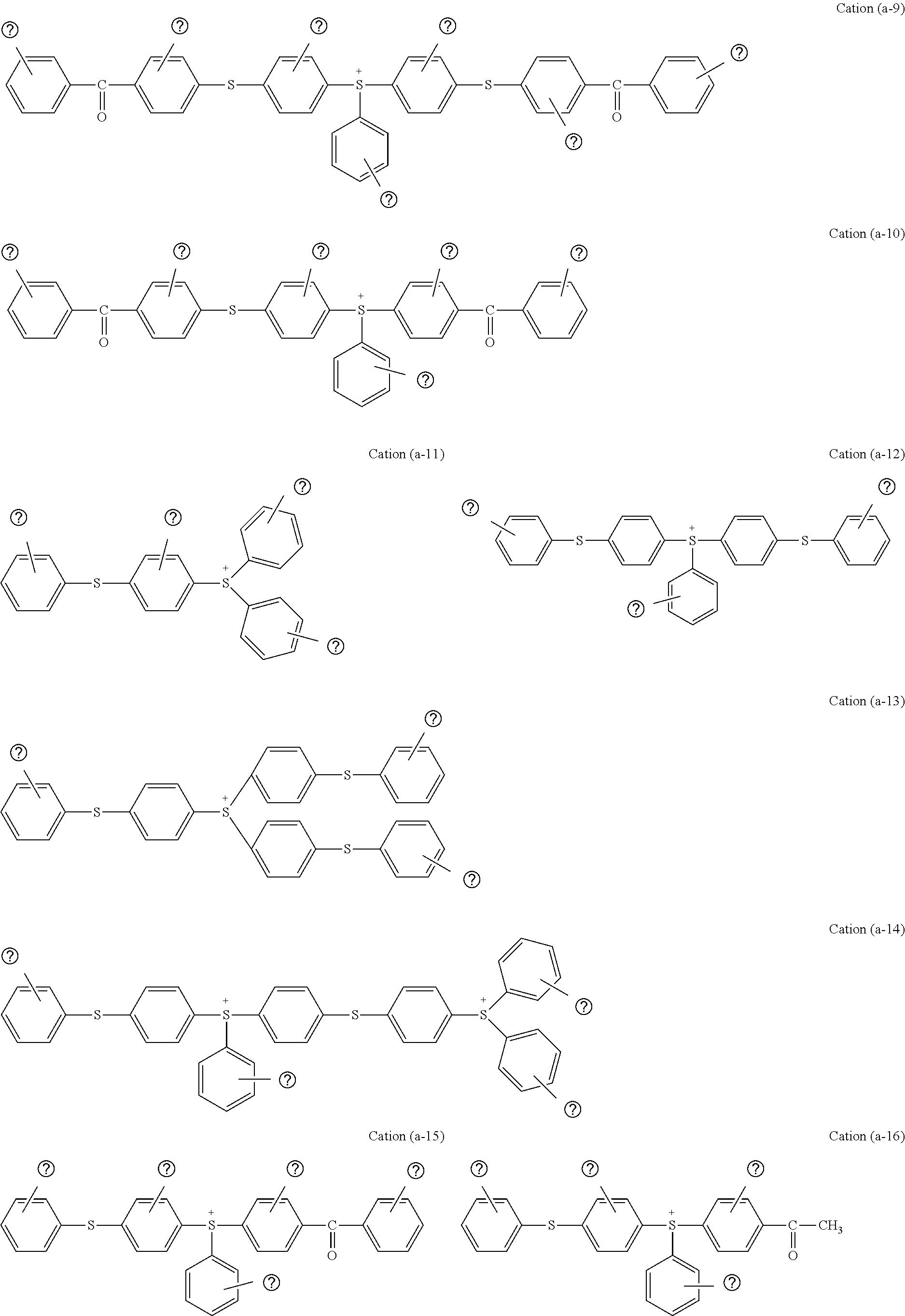

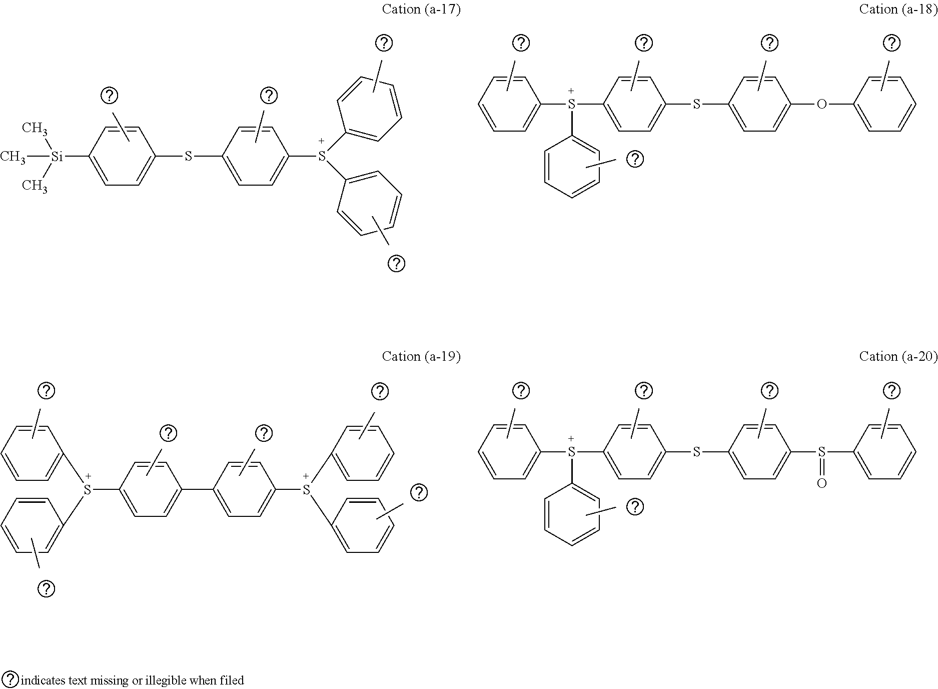

wherein “hal” represents chlorine or fluorine atom, and “f”, which represents the number of substituents of the plural substituents (hal)_{f} in a cation group, is independently 0 or 1.

In another preferred embodiment of the present invention, the anion represented by formula [P—F₆₋ₙ(Rf)ₙ] in the aromatic sulfonium compound is selected from the group consisting of the following anions (b-1) to (b-12):

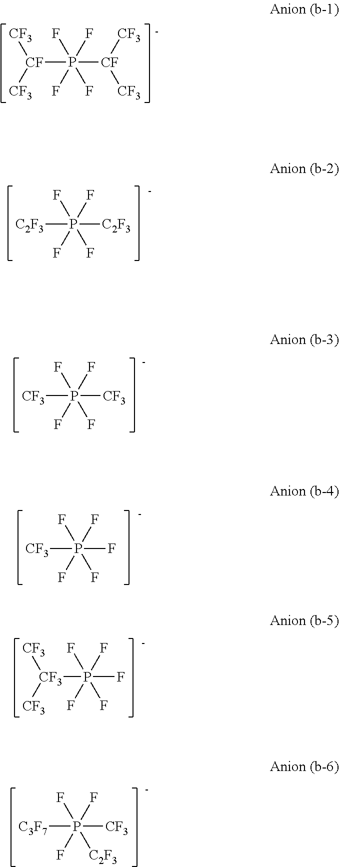

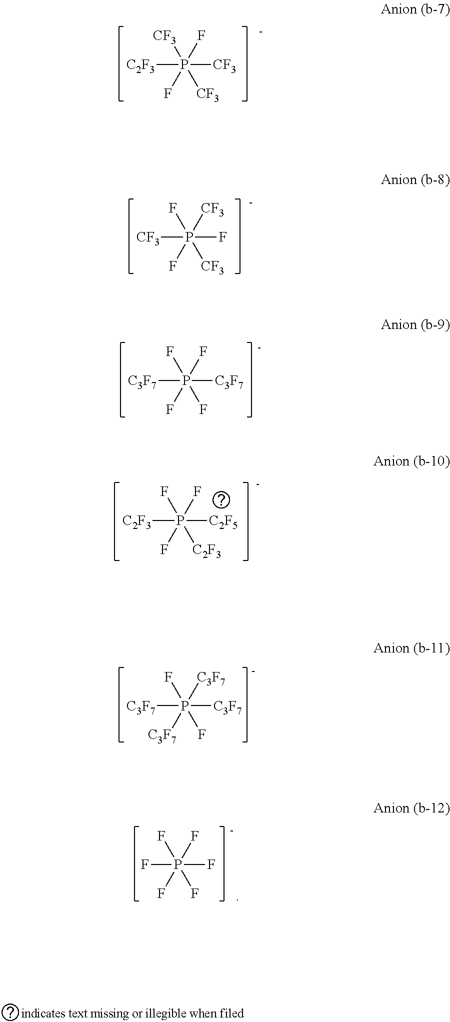

In a preferred embodiment of the present invention, the photo-acid generator (D) is the combination of cation (a-11) and anion (b-2).

Examples of commercially available aromatic sulfonium compound include, but are not limited to, CPI-100P, CPI-110P, CPI-200K, CPI-210S, CPI-500K and CPI-500P, all of which are from SAN-APRO LIMITED; and ADEKAOPTOMER SP-150, ADEKAOPTOMER SP-152, and ADEKAOPTOMER SP-300, all of which are available from ADEKA CORPORATION, Preferably, the aromatic sulfonium compound is the one under the trade name of CPI-200K from SAN-APRO LIMITED.

Preferably, the amount of component (D) is from 0.5 to 5 wt. %, preferably from 1 to 3 wt. %, each based on the total weight of the composition. If the amount of component (D) is higher than 5 wt. %, the amount of the acid generated after UV will be too high, which is not good for the electrical conductivity of the cured composition. If the amount of component (D) is lower than 0.5 wt. %, the tack free time of the composition will be too long, and thus a rapid surface drying cannot be achieved.

### (E) Moisture-Curing Catalyst

According to the present invention, the electrically conductive moisture-curable composition comprises (E) a moisture-curing catalyst.

Preferably, the moisture-curing catalyst used in the present invention is a metal-containing catalyst, preferably a bismuth-containing catalyst.

Examples of the moisture-curing catalyst include, but are not limited to, dibutyltin oxide, dibutyltin diacetate, dibutyltin dilaurate, dibutyltin diacetylacetonate, dioctyltin dilaurate, dioctyltin diacetate, tin (II) acetate, tin (II) octanoate, tin (II) acetylacetonate, titanium (V) isopropylate, potassium neodecanoate, indium neodecanoate, zirconium (IV) acetylacetonate, copper naphthenate, iron (III) acetylacetonate, iron naphthenate, zinc acetylacetonate, zinc 2-ethylhexanoate, zinc neodecanoate, bismuth 2-ethylhexanoate, bismuth neodecanoate, and bismuth tetramethylheptanedionate. Preferably, examples of the moisture-curing catalyst include bismuth 2-ethylhexanoate, bismuth neodecanoate, and bismuth tetramethylheptanedionate.

Examples of commercially available moisture-curing catalysts include, but are not limited to, Borchi Kat 22, Borchi Kat VP 0243, Borchi Kat VP 0244 and Borchi Kat 315, all of which are available from OMG-Borchers GmbH; the BICAT products available from Shepherd Chemical Company; and K-Kat K-348 available from KING INDUSTRIES, INC. Preferably, the moisture-curing catalyst used in the present invention is the one under the trade name of Borchi Kat 315 available from OMG Borchers GmbH.

Preferably, the amount of component (E) is from 0.01 to 10 wt. %, preferably from 0.3 to 7 wt. %, and more preferably from 0.5 to 5 wt. %, each based on the total weight of the composition. If the amount of component (E) is higher than 10 wt. %, the stability of the product will be poor, and the composition will become a viscous liquid within 4 hours. If the amount of component (E) is lower than 0.01 wt. %, the cure speed of the composition will be too slow to exhibit an electrical conductivity after 7 days.

### (F) Electrically Conductive Filler

According to the present invention, the electrically conductive moisture-curable composition comprises (F) an electrically conductive filler.

The electrically conductive filler is a component that imparts electrical conductivity to the cured product of the composition according to the present invention. Examples of the electrically conductive filler include, but are not limited to, metal particles, such as particles of silver, gold, platinum, palladium, nickel, copper and their alloys; particles coated with a metal (such as silver, gold, platinum, palladium, nickel, copper and their alloys); carbon black, carbon fiber, carbon nanotube and graphene. Preferably, the electrically conductive filler used in the present invention may be silver, copper, gold or silver-coated particles. More preferably, the electrically conductive filler is silver or silver-coated core particles. Most preferably, the electrically conductive filler is silver.

In the present invention, the electrically conductive filler may be spherical particles, flakes, rods, wires, nanoparticles or a combination of these. In a preferred embodiment of the present invention, the electrically conductive filler has a specific surface area of 0.4 to 3.5 m²/g. Preferably, when a silver power is used as the electrically conductive filler, it may have a specific surface area of 0.5 to 2.9 m²/g.

Examples of commercially available electrically conductive filler include, but are not limited to: Silflake 135, available from Technic; SF-29, available from Ames Advanced Materials; SF-3, SF-3J, and SF-C, all available from Ames Goldsmith; RA-0127, AA3462, P629-3, P629-4, AC-4044, and SF-11, all of which are available from Metalor; and combinations thereof. Preferably, the electrically conductive filler used in the present invention is the one under the trade name of RA-0127 available from Metalor.

Preferably, the amount of component (F) is from 50 to 95 wt. %, preferably from 55 to 90 wt. %, and more preferably from 65 to 80 wt. %, each based on the total weight of the composition. If the amount of component (F) is higher than 95 wt. %, the electrically conductive filler cannot be well dispersed in the composition. If the amount of component (F) is lower than 50 wt. %, the composition will have no sufficient electrical conductivity.

### (G) Additive

In some embodiments of the present invention, the electrically conductive moisture-curable composition may further optionally comprise (G) additives which are commonly used in the art to which the present invention belongs, such as an antioxidant, a light stabilizer, a UV absorber, and a rheological auxiliary, as long as they do not negatively affect the desired technical effects of the inventive composition.

An example of the antioxidant used in the present invention is the one under the trade name of Irganox 1010 available from BASF.

Examples of the light stabilizer used in the present invention include, but are not limited to, hindered amine light stabilizers.

Examples of the UV absorber used in the present invention include, but are not limited to, salicylate UV absorbers, phenylketone UV absorbers, and benzotriazole UV absorbers.

The presence, the type and the amount of the additive can be determined by a specialist in the art according to actual requirements.

In a preferred embodiment of the present invention, the electrically conductive moisture-curable composition according to the present invention comprises:
(A) from 3 to 50 wt. %, preferably from 5 to 35 wt. %, more preferably from 5 to 25 wt. %, of a polyfunctional silane compound having at least two alkoxysilane groups, each based on the total weight of the composition;
(B) from 0.3 to 1 wt. %, preferably from 0.4 to 0.8 wt. %, of a moisture scavenger, each based on the total weight of the composition;
(C) from 0.5 to 20 wt. %, preferably from 1 to 8 wt. %, of an alkoxysilane isocyanurate compound and optionally an epoxy functional silane coupling agent, each based on the total weight of the composition;
(D) from 0.5 to 5 wt. %, preferably from 1 to 3 wt. %, of a photo-acid generator, which is a sulfonium salt, each based on the total weight of the composition;
(E) from 0.01 to 10 wt. %, preferably from 0.3 to 7 wt. %, and more preferably from 0.5 to 5 wt. %, of a moisture-curing catalyst, each based on the total weight of the composition;
(F) from 50 to 90 wt. %, preferably from 55 to 90 wt. %, and more preferably from 65 to 80 wt. %, of an electrically conductive filler, each based on the total weight of the composition; and
(G) optionally, an antioxidant.

The electrically conductive moisture-curable composition according to the present invention can be prepared by any conventional preparation methods in the art. Preferably, the composition according to the present invention may be prepared by a method comprising the following steps: adding components (C), (D) and (G) (if any), and dispersing them to be homogeneous; adding component (F), and dispersing the mixture obtained to be homogeneous; adding component (B), and dispersing the mixture obtained to be homogeneous; adding component (A), and dispersing the mixture obtained to be homogeneous; adding component (E), and dispersing the mixture obtained to be homogeneous; and discharging the final mixture as soon as possible and deaerating it to remove the air therein. The preparation of the composition is preferably carried out in a controlled temperature and humidity environment; and more preferably, the preparation is carried out at a temperature lower than 25° C. and a relative humidity lower than 50%. The mixer used in the preparation may be any conventional mixing device used in the art, such as a SpeedMixer or ROSS Mixer. The composition obtained from the above is preferably stored at −40° C.

In a second aspect, the present disclosure is directed to a method of applying the electrically conductive moisture-curable composition according to the present invention comprising: applying the composition on a substrate, UV curing the composition to obtain a cured product, and then moisture curing the cured product.

In a preferred embodiment, the composition according to the present invention may be applied on a substrate by dispensing; the applied composition may be UV cured, preferably with a UV LED light source having a wavelength of 365 nm, wherein the light intensity of the LED light source is preferably from 1.0 to 5 W/cm², and the curing time is preferably from 1 second to 10 seconds; and then the UV-cured product obtained from the above UV curing step may be further cured by moisture reactive species therein, i.e. moisture-cured at ambient conditions, wherein during the moisture curing, the cured product is preferably placed at 18 to 25° C. and a relative humidity of from 30 to 40%. In the moisture curing, the curing speed is affected by the temperature and the humidity; and generally, the temperature and/or the humidity is higher, the curing speed is faster.

In a third aspect, the present disclosure is directed to a cured product of the electrically conductive moisture-curable composition according to the present invention, an article comprising the cured product, and a use of the composition or the cured product in electronic device.

The electrically conductive moisture-curable composition according to the present invention may be used in electronic device, preferably those where an electrical conductivity or antistatic property is desired.

The electrically conductive moisture-curable composition according to the present invention comprising a combination of components (A) to (F) can be cured at room temperature with a fast surface drying and a good stability, and has a low resistivity; and in particular, it exhibits a combination of a tack free time (No UV)>4 hours, a tack free time (LED 365 nm, 3 w/cm²*2 s)≤2 minutes, a liquid state at room temperature (RT) after 4 hours (No UV), a conductivity after 7 days≤0.05 ohm*cm, and a curing depth after 24 hours≥0.5 mm.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Raw Materials:

### Component (A):

Component a-1: Geniosil STPE-10, CAS No. 611222-18-5, available from Wacker, which has the following structure:

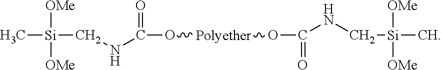

Component a-2: Geniosil XB502, available from Wacker, which is a mixture of a polymer of formula (III) in the present invention and a silsesquioxane terminated by a methoxy at a weight ratio of about (25 to 30)/(70 to 75).

### Component (B):

Component b-1: Dynasylan VTMO, available from Evonik, which has the following structure:

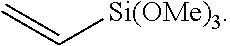

### Component (C):

Component c-1: Dynasylan 7163, available from Evonik, which has the following structure:

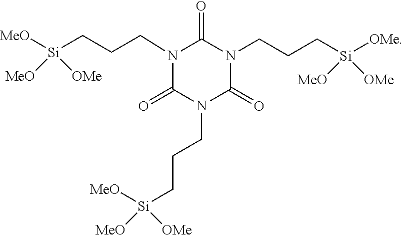 [SMILES: CO[Si](CCCn1c(=O)n(CCC[Si](OC)(OC)OC)c(=O)n(CCC[Si](OC)(OC)OC)c1=O)(OC)OC]

Component c-2: Dynasylan 4721, available from Evonik, which has the following structure:

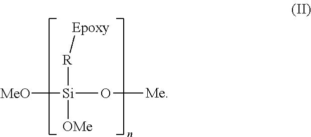

Component c-3: Silquest A-187, available from Momentive, which has the following structure:

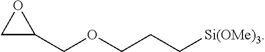

### Component (D):

Component d-1: CPI 200K, available from SAN-APRO, which has the following structure:

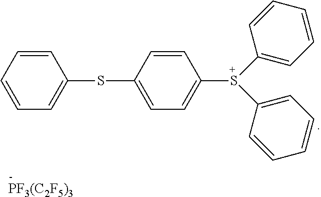

Component d-2′: SpeedCure 939, 4-isopropyl-4′-methyldiphenyliodonium tetrakis-(pentafluorophenyl)borate, available from Lambson.
Component d-3′: Omnirad 184, 1-hydroxycyclohexyl-phenyl ketone, available from LGM.

### Component (E):

Component e-1: Borchi Kat 315, available from OMG.
Component e-2′: Dynasylan AMMO, 3-aminopropyltrimethoxysilane, available from Evonik.

### Component (F):

Component f-1: RA-0127, a silver filler, available from Metalor.

### Component (G):

Component g-1: Irganox 1010, an antioxidant, available from BASF.

### Examples 1 to 4 (Ex. 1 to Ex. 4) and Comparative Examples 1 to 4 (CEx. 1 to CEx. 4)

Specific amounts and types of components in the electrically conductive moisture-curable composition of Examples 1 to 4 according to the present invention and Comparative Examples 1 to 4 are shown in Tables 1-2. The compositions were prepared as follows: adding components (C), (D) and (G), and dispersing them to be homogeneous; adding component (F), and dispersing the mixture obtained to be homogeneous; adding component (B), and dispersing the mixture obtained to be homogeneous; adding component (A), and dispersing the mixture obtained to be homogeneous; adding component (E), and dispersing the mixture obtained to be homogeneous; and discharging the final mixture as soon as possible and deaerating it to remove the air therein. The preparation of the composition was carried out at 23° C. and a relative humidity of 40%. The mixer used in the preparation was Speedmixer, DAC150.1 FVZ-K, available from Flacktek, Inc. The composition obtained from the above was stored at −40° C.

### Test Methods:

### Tack Free Time (No UV):

Each of the compositions of Ex. 1 to 4 and CEx, 1 to 4 was dispensed on a glass substrate, the substrate with the composition was placed in a 25° C./50% RH environment, and then the surface of the composition was touched every three minutes to see if the surface became a solid film.

Tack Free Time (with UV):

Each of the compositions of Ex. 1 to 4 and CEx. 1 to 4 was dispensed on a glass substrate, the substrate with the composition was UV-cured under a LED 365 nm light source having a power of 3 w/cm² for 2 s and then placed in a 25° C./50% RH environment, and finally the surface of the composition was touched every one minute in the first five minutes and then every three minutes to see if the surface became a solid film.

State after 4 Hours at Room Temperature (RT) (No UV):

Each of the compositions of Ex. 1 to 4 and CEx. 1 to 4 was dispensed on a glass substrate, the substrate with the composition was placed in a 25° C./50% RH environment, and then the state of the paste was checked after 4 hours.

Conductivity after 7 Days (Ohm*Cm):

Electrical conductivity after 7 days was measured for each of the compositions of Ex. 1 to 4 and CEx. 1 to 4 according to ASTM D991 with Agilent 34401A.

Curing Depth after 24 Hours:

Each of the compositions of Ex. 1 to 4 and CEx. 1 to 4 was dispensed in an aluminium plate, the substrate with the composition was placed in a 25° C./50% RH environment, and then the thicknesses of the compositions were measured after 24 hours.

The tack free time (no UV), the tack free time (with UV), the state after 4 hours RT (No UV), the conductivity after 7 days and the curing depth after 24 hrs of the compositions were tested using the methods stated above respectively, and the results thereof are shown in Tables 1 to 2 as below.

TABLE 1

| Components | | | | | | | |
|---|---|---|---|---|---|---|---|
| (weight in g) | | Ex. 1 | Ex. 2 | Ex. 3 | Ex. 4 | CEx. 1 | CEx. 2 |
| (A) | a-1 | 5.7 | 5.7 | 5.7 | 5.7 | 5.7 | 5.7 |
| | a-2 | 17.05 | 17.05 | 17.05 | 17.05 | 17.05 | 17.05 |
| (B) | b-1 | 0.6 | 0.6 | 0.6 | 0.6 | 0.6 | 0.6 |
| (C) | c-1 | 3 | 3 | 3 | 3 | | |
| | c-2 | | | | | | |
| | c-3 | | 3 | 3 | 3 | | 3 |
| (D) | d-1 | 2 | 2 | 2 | 2 | | 2 |
| (E) | e-1 | 2 | 2 | 1 | 5 | 0.08 | 2 |
| | e-2′ | | | | | 1.7 | |
| (F) | f-1 | 74 | 74 | 74 | 74 | 74 | 74 |
| (G) | g-1 | 0.3 | 0.3 | 0.3 | 0.3 | 0.1 | 0.3 |

| | | | | | | |
|---|---|---|---|---|---|---|
| Total weight of the composition | 104.65 | 107.65 | 106.65 | 110.65 | 99.23 | 101.65 |

Test results

| | | | | | | |
|---|---|---|---|---|---|---|
| Tack free time (No UV) | >4 hrs | >4 hrs | >4 hrs | >4 hrs | 18 mins | >4 hrs |
| Tack free time (LED 365 nm, | 2 mins | 2 mins | <1 min | 2 mins | N/A | 7 mins |
| 3 w/cm²*2 s) | | | | | | |
| State after 4 hrs RT | Flowing | Flowing | Flowing | Sticky | 0.5 mm | Flowing |
| (No UV) | liquid | liquid | liquid | liquid | film | liquid |
| Conductivity after | 0.005 | 0.005 | 0.05 | 0.0003 | 0.0005 | 0.075 |
| 7 days, ohm*cm | | | | | | |
| Curing depth after | 1.19 | 1.25 | 1.04 | 2.17 | 1.8 | Thin, |
| 24 hrs, mm | | | | | | cannot be |

detected

TABLE 2

| Components | | |
|---|---|---|
| (weight in g) | CEx. 3 | CEx. 4 |

| (A) | a-1 | 5.7 | 5.7 |
|---|---|---|---|
| | a-2 | 17.05 | 17.05 |
| (B) | b-1 | 0.6 | 0.6 |
| (C) | c-1 | | 3 |
| | c-2 | 3 | |
| | c-3 | 3 | 3 |
| (D) | d-1 | 2 | |
| | d-2′ | | 1 |
| | d-3′ | | 1 |
| (E) | e-1 | 2 | 2 |
| | e-2′ | | |
| (F) | f-1 | 74 | 74 |
| (G) | g-1 | 0.3 | 0.3 |

| Total weight of the | 107.65 | 107.65 |
|---|---|---|
| composition (in g) | | |

Test results

| | | | | |
|---|---|---|---|---|
| Tack free time (No UV) | >4 | hrs | >4 | hrs |
| Tack free time (LED 365 | 20 | mins | 60 | mins |
| nm, 3 w/cm²*2 s) | | | | |

| State after 4 hrs RT (No UV) | Flowing liquid | Sticky liquid |
|---|---|---|
| Conductivity after 7 | Cannot be | 0.2 |
| days, ohm*cm | detected | |
| Curing depth after 24 hrs, mm | | 4.27 |

From the data in Tables 1 & 2, it can be seen that, the electrically conductive moisture-curable composition according to the present invention (Ex.1 to Ex.4), which comprises a combination of components (A) to (F), can be cured at room temperature with a fast surface dry and a good stability, and has a low resistivity; and in particular, it exhibits a combination of a tack free time (No UV)>4 hours, a tack free time (LED 365 nm, 3 w/cm²*2 s)≤2 minutes, a liquid state at room temperature (RT) after 4 hours (No UV), a conductivity after 7 days S 0.05 ohm*cm, and a curing depth after 24 hours≥0.5 mm.

In contrast, the epoxy compositions which are not according to the present invention (CEx. 1 to CEx. 4) did not exhibit a combination of a tack free time (No UV)>4 hours, a tack free time (LED 365 nm, 3 w/cm²*2 s) S 2 minutes, a liquid state at room temperature (RT) after 4 hours (No UV), a conductivity after 7 days K 0.05 ohm*cm, and a curing depth after 24 hours≥0.5 mm. For example, CEx.1 (comprising no components (C) and (D) in the present invention) exhibited a tack free time (No UV) of 18 minutes, and a 0.5 mm film at RT after 4 hours (No UV); CEx. 2 & CEx.3 (both of which comprise no alkoxysilane isocyanurate compound in the present invention) exhibited tack free times (LED 365 nm, 3 w/cm²*2 s) which are much higher than 2 minutes (7 min. and 20 min. respectively), conductivities after 7 days which is higher than 0.05 ohm*cm or cannot be detected, and curing depths after 24 hours which are not suitable; and CEx. 4 (containing an iodonium photo-acid generator and a photo-initiator, instead of component (D) in the present invention) exhibited a tack free times (LED 365 nm, 3 w/cm²*2 s) of 60 minutes, and a conductivity after 7 days of 0.2 ohm*cm.

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. An electrically conductive moisture-curable composition comprising:
(A) polyfunctional silane compound having at least two alkoxysilane groups,
(B) a moisture scavenger,
(C) an alkoxysilane isocyanurate compound and optionally an epoxy functional silane coupling agent,
(D) a photo-acid generator, which is a sulfonium salt,
(E) a moisture-curing catalyst, and
(F) an electrically conductive filler.

2. The electrically conductive moisture-curable composition according to claim 1, wherein the alkoxysilane isocyanurate compound of (C) is represented by the following general formula (I): 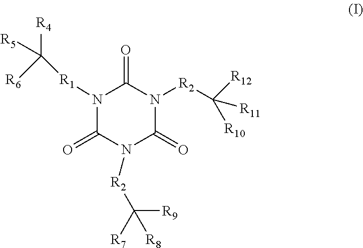
wherein R₁, R₂ and R₃ are each independently of the other C₁-C₈ alkyl, and each of R₄ to R₁₂ is independently of the other C₁-C₄ alkyl or C₁-C₄ alkoxy, with the proviso that at least one of R₄ to R₁₂ is C₁-C₄ alkoxy.

3. The electrically conductive moisture-curable composition according to claim 1, wherein the alkoxysilane isocyanurate compound is selected from the group consisting of 1,3,5-tris(trimethoxysilylpropyl)isocyanurate, 1,3,5-tris(methyldimethoxysilylpropyl)isocyanurate, 1,3,5-tris(methyldiethoxysilylpropyl)isocyanurate, 1,3,5-tris(trimethoxysilylbutyl)isocyanurate, 1,3,5-tris(methyldimethoxysilylbutyl)isocyanurate, 1,3,5-tris(triethoxysilylpropyl)isocyanurate, and combinations thereof.

4. The electrically conductive moisture-curable composition according to claim 1, wherein the photo-acid generator (D) is an aromatic sulfonium compound represented by the following general formula (II): 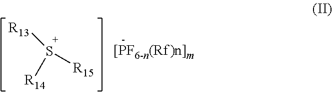
wherein R₃, R₁₄ and R₁₅ each independently represent a monovalent aromatic group which may have a substituent on an aromatic ring, the monovalent aromatic group may optionally have one or two or more of a bond selected from —S— (thioether bond), —SO— (sulfoxide bond), —O— (ether bond) and —O— (carbonyl bond); Rf represents a fluoroalkyl group, m is the same number as the cationic charge of the “cation [S⁺(R₁₃)(R₁₄)(R₁₅)]”, and n is an integer in a range of 0 to 6.

5. The electrically conductive moisture-curable composition according to claim 4, wherein Rf represents a C1-C4 fluoroalkyl group.

6. The electrically conductive moisture-curable composition according to claim 4, wherein the cation [S⁺(R₁₃)(R₁₄)(R₁₅)] in the aromatic sulfonium compound is selected from the group consisting of the following cations (a-1) to (a-20): 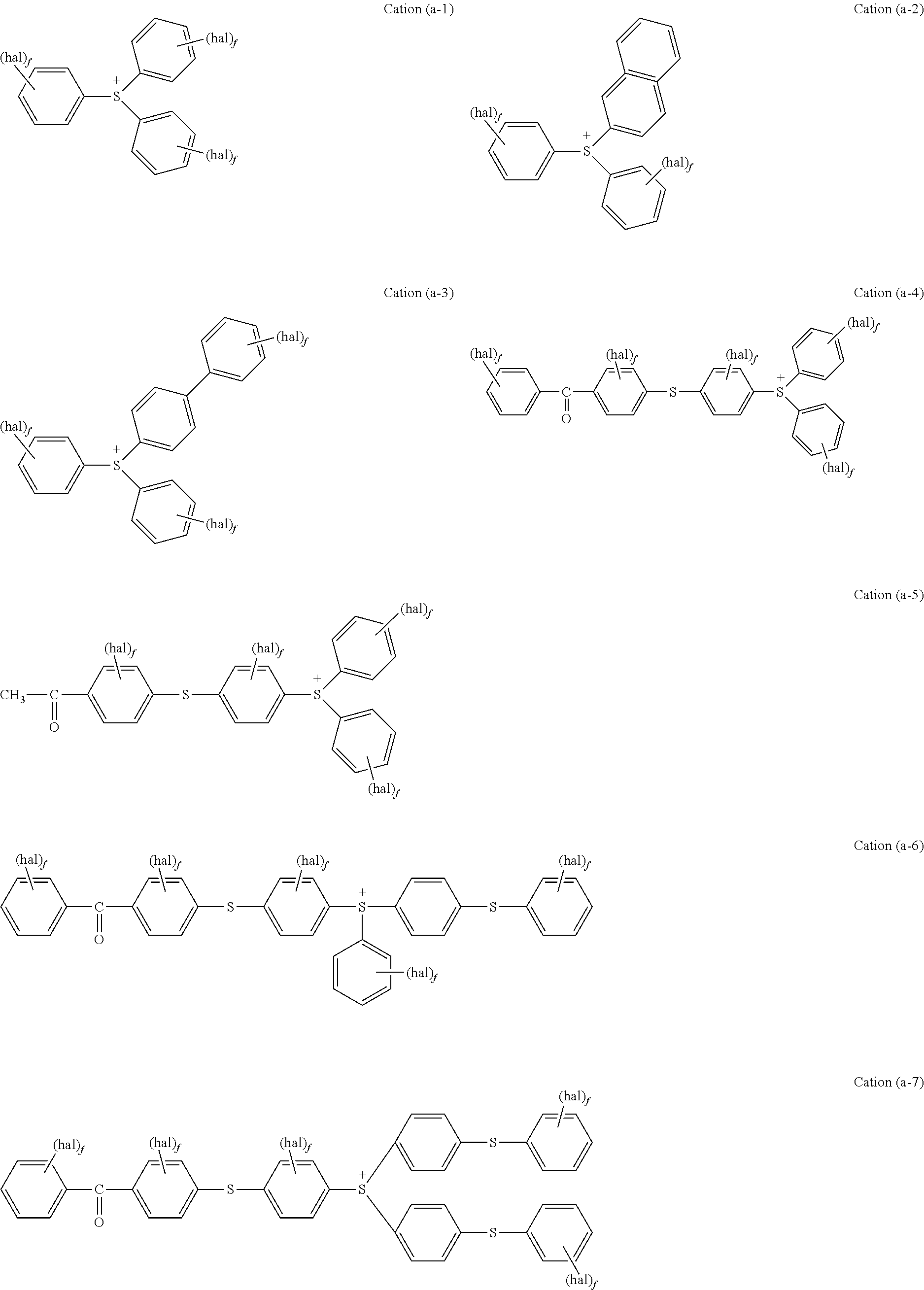 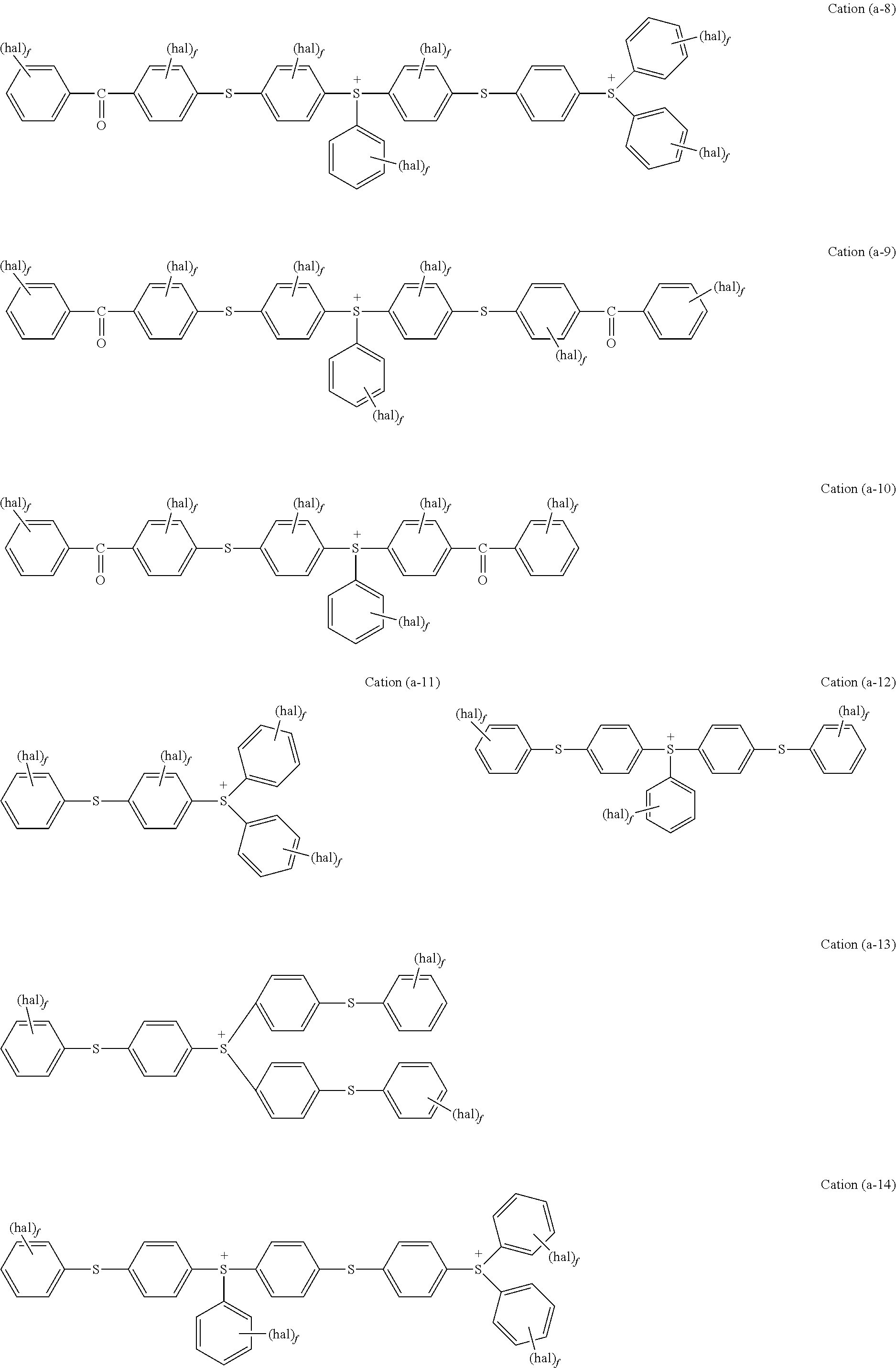 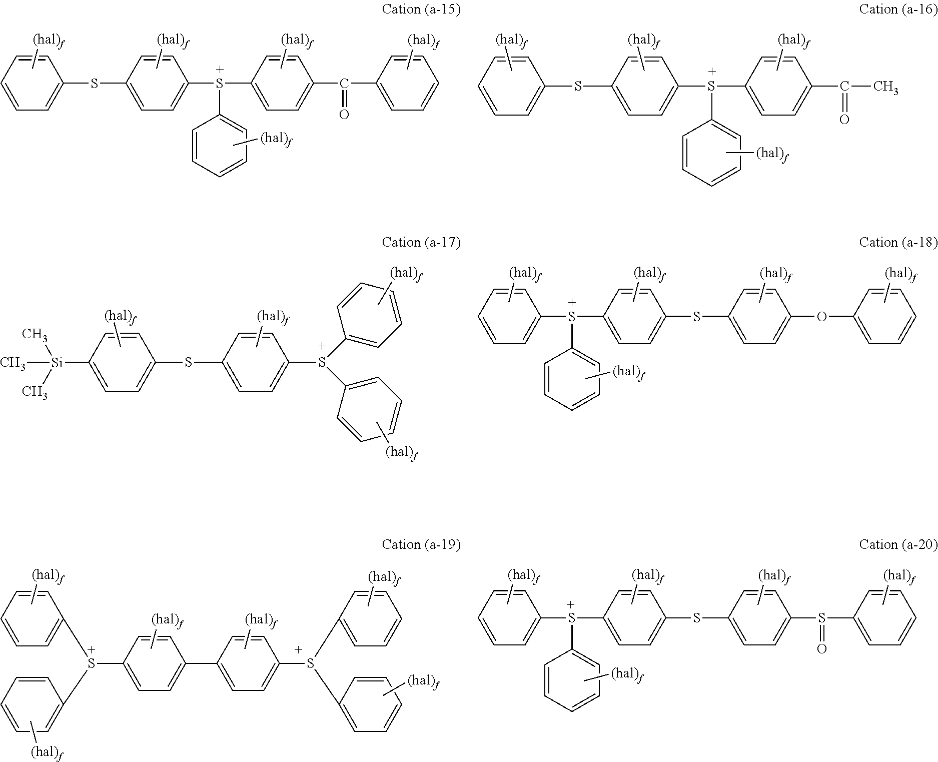
wherein “hal” represents chlorine or fluorine atom, “f”, which represents the number of substituents of the plural substituents (hal)_{f} in a cation group, is independently 0 or 1; and/or
the anion represented by formula [P—F₆₋ₙ(Rf)ₙ] in the aromatic sulfonium compound is selected from the group consisting of the following anions (b-1) to (b-12):

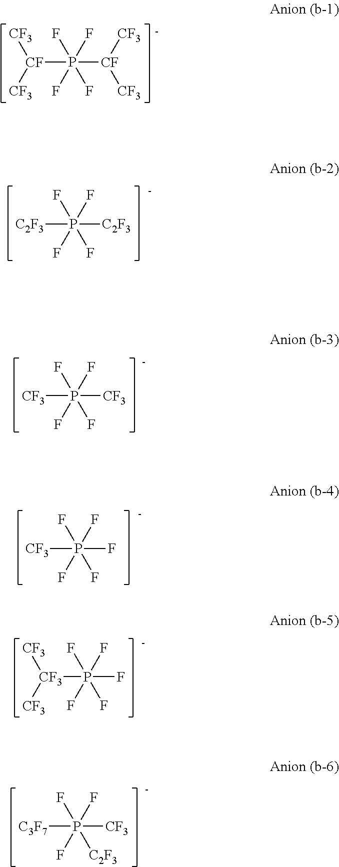

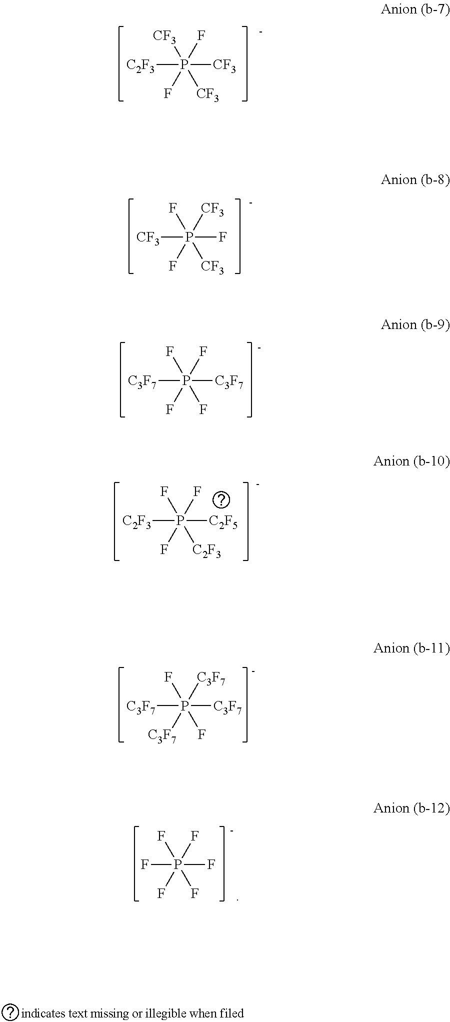

7. The electrically conductive moisture-curable composition according to claim 1, wherein the polyfunctional silane compound having at least two alkoxysilane groups (A) comprises one or more at least bifunctional α-alkoxysilane compounds, which corresponds to the following formula (III): 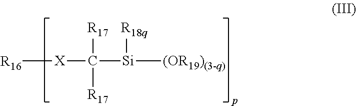
wherein
R₁₆ is an at least divalent organic residue,
each R₁₇, independently, is a monovalent residue that is selected from the group consisting of hydrogen, linear, branched, cyclic, saturated, unsaturated and aromatic hydrocarbons and, optionally, may be halogen-substituted and/or interrupted by 1 to 3 heteroatoms,
each R₁₈, independently, is a monovalent residue that is selected from the group consisting of linear, branched, cyclic, saturated, unsaturated and aromatic hydrocarbons and, optionally, may be halogen-substituted and/or interrupted by 1 to 3 heteroatoms,
each R₁₉, independently, is a monovalent residue that is selected from the group consisting of hydrogen, linear, branched, cyclic, saturated, unsaturated and aromatic hydrocarbons and, optionally, may be halogen-substituted and/or interrupted by 1 to 3 heteroatoms,
X is a heteroatom-containing di- or trivalent residue that is linked, via a heteroatom, in particular oxygen, nitrogen or sulfur, to the —CR₁₇₂—SiR_{18q}(OR₁₉)_{(3-q)} group,
p is at least 2, and
q=0 to 2.

8. The electrically conductive moisture-curable composition according to claim 1, wherein the moisture scavenger (B) is a vinylsilane.

9. The electrically conductive moisture-curable composition according to claim 1, wherein the amount of component (C) is from 0.5 to 20 wt. %, each based on the total weight of the composition.

10. The electrically conductive moisture-curable composition according to claim 1, wherein the amount of component (D) is from 0.5 to 5 wt. %, each based on the total weight of the composition.

11. The electrically conductive moisture-curable composition according to claim 1, further comprising an additive (G) which is selected from the group consisting of an antioxidant, a light stabilizer, a UV absorber, a rheological auxiliary and combinations thereof.

12. The electrically conductive moisture-curable composition according to claim 1, which can be cured at room temperature.

13. A method of applying the electrically conductive moisture-curable composition according to claim 1, comprising: applying the composition on a substrate, UV curing the composition to obtain a cured product, and then moisture curing the cured product.

14. A cured product of the electrically conductive moisture-curable composition according to claim 1.

15. An article comprising the cured product according to claim 14.

16. An electronic product or component thereof comprising a substrate having adhered thereto the cured product of claim 14 wherein said cured product exhibits a conductivity after 7 days≤0.05 ohm*cm, and a curing depth after 24 hours≥0.5 mm.
